(19) United States
(12) Patent Application Publication
(10) Pub. No.: US 2008/0170594 A1
(43) Pub. Date: Jul. 17, 2008

(54) SYSTEM AND METHOD FOR REALIZING NETWORK SYNCHRONIZATION BY PACKET NETWORK

(75) Inventor: Zhijun QU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/035,938

(22) Filed: Feb. 22, 2008

Related U.S. Application Data
(63) Continuation of application No. PCT/CN2006/002130, filed on Aug. 22, 2006.

(30) Foreign Application Priority Data
Aug. 24, 2005 (CN) 200510093014.3

(51) Int. Cl. H04J 3/06

(52) U.S. Cl. 370/512; 370/503

(57) ABSTRACT

A system and method for realizing network synchronization by packet network mainly includes: restoring the clock signal from the superior processing equipment data link of the packet network, and sending it to the subordinate processing equipment; realizing the synchronization of said processing equipment based on said clock signal. It can realize the uniform timing of the whole network and change the IP network without the timing into the synchronous network, which is similarly with the circuit network, with high bandwidth. It can not only provide a circuit simulation service, but also a multi-service with high bandwidth.

### CROSS-REFERENCE TO RELATED APPLICATIONS

This application is a continuation of International Patent Application No. PCT/CN2006/002130, filed Aug. 22, 2006, which claims priority to Chinese Patent Application No. 200510093014.3, filed Aug. 24, 2005, both of which are hereby incorporated by reference.

### FIELD OF THE INVENTION

The present invention relates to the communication field and in particular to a method and system for network synchronization over a packet network.

### BACKGROUND OF THE INVENTION

Existing networks can generally be divided into two major types. One type is a synchronized circuit domain network which currently provides telephone service and can strictly guarantee a transmission delay and a transmission sequence of the service through synchronization timing throughout the network. The other type is a connectionless IP packet network which provides Internet data service and does not strictly guarantee the transmission delay or the transmission sequence of packets.

As multi-service is required and IP packet network is deployed on a large scale, the bandwidth that the IP packet network can offer is increased, and the cost of deploying the IP packet network is reduced. Therefore, more and more providers tend to bear the multi-service through the IP. However, the existing IP network is still a connectionless network without synchronization. When service of Best effort is provided, in some aspects, especially in respect of synchronization timing throughout the network, requirement on circuit service can not be met. Therefore, some providers propose solutions for provision of synchronization timing over an IP packet network, for example, some providers propose solutions of Real time Transport Protocol (RTP), Adaptive Clock Recovery (ACM). However, these solutions fail to solve essentially the problem of provision of timing throughout the IP packet network and pose to the contrary a high requirement on the network, which includes a transmission delay over the network, a packet loss ratio over the network. The deterioration of any index may have deadly influence on the above solutions.

Currently, an optional technical solution for network synchronization over an IP packet network is that a synchronization timing network is built together with the IP packet network in order to implement provision of circuit service over the IP packet network, and a method of superposition is adopted to meet requirement on network synchronization.

A synchronization network has to be built newly in the existing solution, which results in a drawback of a high network building cost. Further, a data network and a circuit network have not been unified completely in the existing solution, which results in relatively difficult maintenance operations.

### SUMMARY OF THE INVENTION

In view of above, there is provided a system and method for network synchronization over a packet network, whereby uniform timing throughout the network can be implemented properly, the IP packet network without timing is rebuilt into a synchronized network similar to a circuit network, and the advantage of a high bandwidth of the IP packet network remains. Thus, both service of circuit simulation and multi-service of high-bandwidth may be provided.

Technical solutions according to embodiments of the present invention are as follows.

There is provided a system for network synchronization over a packet network, including processing devices at different levels, a transmission module, and a reception module;

the reception module is adapted to recover a clock signal from a data link interfaced with a processing device at upper level of the plurality of processing devices and to transmit the recovered clock signal to the transmission module; and

the transmission module is adapted to receive and transmit the recovered clock signal to a processing device at lower-level of the plurality of processing devices, and/or adapted to receive the recovered clock signal and transmission data signals with the received clock signal, and to transmit the mixed signals to the processing device at lower-level.

Alternative technical solutions according to embodiments of the present invention are as follows.

The transmission module and the reception module are provided in an interface board or a service board.

The reception module includes a clock processing unit, an MAC layer processing unit, and a physical layer processing unit;

the physical layer processing unit is adapted to recover the clock signal from the data link with the processing device at upper-level and to transmit the recovered clock signal to the MAC layer processing unit and the clock processing unit;

the clock processing unit is adapted to process the received recovered clock signal and to transmit a reference clock obtained by processing to the physical layer processing unit and the MAC layer processing unit, so that the physical layer processing unit and the MAC layer processing unit transmit periodically the reference clock as a line clock to the lower-level processing device via the transmission module; and

the MAC layer processing unit is adapted to receive the data transmitted from the physical layer processing unit by using the clock signal recovered by the physical layer processing unit and to transmit the data to the physical layer processing unit by using the reference clock transmitted from the clock processing unit.

The transmission module includes a physical layer processing unit, a clock processing unit, and an MAC layer processing unit;

the physical layer processing unit is adapted to receive data by using the recovered clock signal or the line clock signal transmitted from the processing device at upper-level and to mix in a code mode the transmission data signals with the line clock signal transmitted from the processing device at upper-level or to transmit the line clock signal transmitted from the processing device at upper-level to the MAC layer processing unit for reception of the data and to the clock processing unit for processing;

the clock processing unit is adapted to process the received clock signal and to transmit a reference clock obtained by processing to the physical layer processing unit and the MAC layer processing unit, so that the physical layer processing unit and the MAC layer processing unit transmit periodically the reference clock as a line clock to a processing device at next-level; and

the MAC layer processing unit is adapted to receive the data transmitted from the physical layer processing unit by using the upper-level line clock signal transmitted from the physical layer processing unit and to transmit the data to the physical layer processing unit by using the reference clock transmitted from the clock processing unit.

A master control board is provided between the reception module and the transmission module, and is adapted to lock the recovered clock signal transmitted from the reception module and to drive the locked clock signal into multiple signals transmitted to the transmission module.

The master control board includes a phase locked loop circuit adapted to lock the clock signal.

The master control board further includes a signal drive circuit adapted to drive the clock signal into multiple signals and to transmit the multiple signals to the corresponding transmission module.

The system further includes a switching backplane adapted to input the clock signal recovered by the reception module to the master control board and to input a signal output from the master control board to the transmission module.

There is further provided a method for network synchronization over a packet network, including:

A. recovering a clock signal over a data link interfaced with a processing device at upper-level in a packet network and transmitting the recovered clock signal to a processing device at lower-level; and

B. synchronizing the processing devices by means of the clock signal.

Particularly, the step A includes:

A1. receiving data transmitted from the processing device at upper-level in the packet network over the data link and recovering the clock signal from the data link; and

A2. mixing data signals with the recovered clock signal and transmitting the mixed signals to the processing device at lower-level.

Particularly, the step B includes:

B1. recovering, by the processing device at lower-level, the clock signal for use in transmission of the data from the data link; and

B2. providing, by the processing device at lower-level, the processing devices with a clock by using the clock signal, mixing the clock signal with the data signal, and transmitting the mixed signals over a data link within the processing device at lower-level to a processing device at next-level.

As can be seen from the above technical solutions according to embodiments of the present invention, a clock signal over a data link of a processing device at upper-level in a packet network is recovered and transmitted to a processing device at low-level, and the processing devices are synchronized by means of the clock signal. With the present invention, uniform timing throughout the network can be implemented properly, the IP packet network without timing is rebuilt into a synchronized network similar to a circuit network, and the advantage of a high bandwidth of the IP packet network remains. Thus, both service of circuit simulation and multi-service of high-bandwidth may be provided.

### BRIEF DESCRIPTION OF THE DRAWINGS

FIG. 1 illustrates the framework of IP synchronized network devices;

FIG. 2 is an operational principle diagram illustrating an Ethernet interface in an interface board according to embodiments of the present invention;

FIG. 3 is an operational principle diagram illustrating that two different devices are interfaced and interconnected via an Ethernet interface according to embodiments of the present invention;

FIG. 4 is a principle diagram illustrating a method according to embodiments of the present invention; and

FIG. 5 is a schematic diagram illustrating the network architecture of an IP synchronized network according to embodiments of the present invention.

### DETAILED DESCRIPTION OF THE INVENTION

There is provided a system and method for network synchronization over a packet network. According to embodiments of the present invention, a clock signal over a data link coupled with a processing device at upper-level in the packet network is recovered and transmitted to a processing device at lower-level in the packet network, and synchronization between the processing devices is implemented according to the clock signal.

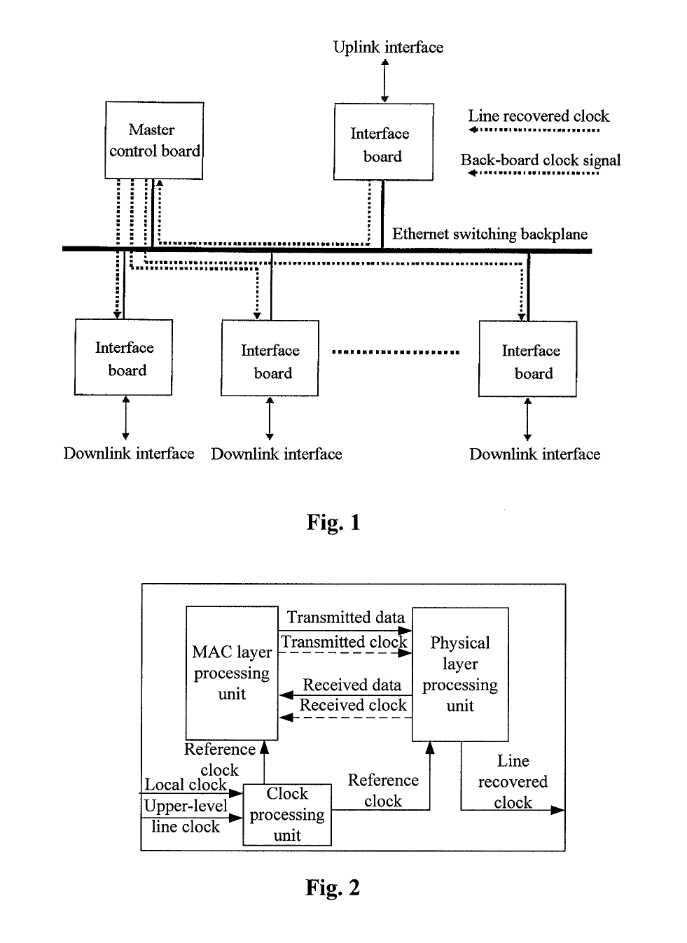

According to a first embodiment of the present invention, the framework of a network device capable of IP synchronization is illustrated in FIG. 1. The network device may be one of a plurality of processing devices at different levels, and the processing device includes a transmission module and a reception module. The transmission module may be provided in a downlink interface board, and the reception module may be provided in an uplink interface board. A switching backplane and a master control board may be provided between the uplink interface board and the downlink interface board. Particularly, the switching backplane may be an Ethernet switching backplane or other IP packet network switching backplanes.

The uplink interface board exchanges data with a processing device at upper-level over a data link via an interface of the uplink interface board. When data is required to be received from the processing device at upper-level, the uplink interface board recovers a clock signal from the data link via the interface and transmits the recovered clock signal to the master control board via the switching backplane. When data is required to be transmitted to the processing device at upper-level, signals of data to be transmitted may be mixed with a reference clock signal obtained by processing the recovered clock signal, and then the mixed signals are transmitted over a data link via an interface of the uplink interface board to the processing device at upper-level.

The master control board is provided with a phase locked loop circuit and a signal drive circuit. The phase locked loop circuit is adapted to lock a clock signal. The signal drive circuit is adapted to drive the locked clock signal into multiple signals which are transmitted to corresponding downlink interface boards via the switching backplane.

The downlink interface board exchanges data with a processing device at lower-level over a data link via an interface of the downlink interface board. When data is required to be transmitted to the processing device at lower-level, the downlink interface board transmits the data by using a locked clock signal transmitted from the master control board. F or example, in the downlink interface board, signals of data to be transmitted are mixed with the locked clock signal, and then the mixed data signals with the locked signal are transmitted over a data link via an interface of the downlink interface board to the processing device at lower-level. When data is required to be received from the processing device at lower-level, a reception clock signal employed may be a clock signal recovered from the data link via the interface interfaced with the processing device at lower-level or a reference clock signal output from a clock processing unit.

Both the uplink interface board and the downlink interface board described above are exchangeable. An y of the interface boards in the system may become uplink or downlink. There fore, any of the interface boards may recover a clock signal from an input line and the recovered clock signal may be transmitted to the master control board so as to be processed. An y of the interface boards may output a recovered clock signal to the master control board and receive a clock signal transmitted from the master control board.

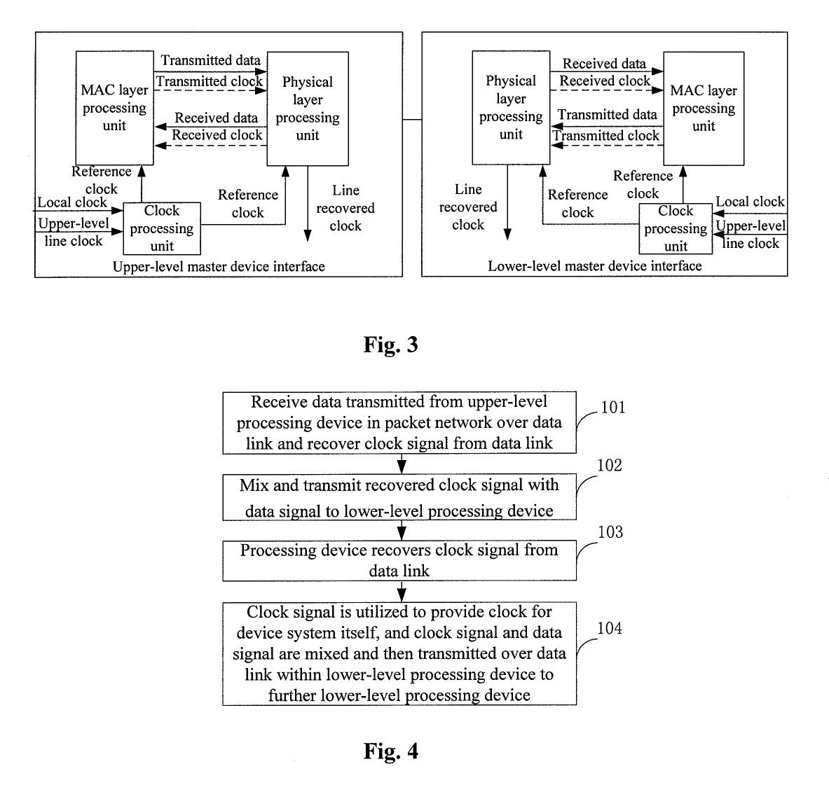

As illustrated in FIG. 2, there is provided in the uplink interface board described above an uplink interface including a clock processing unit, a MAC layer processing unit, and a physical layer processing unit.

Particularly, the physical layer processing unit is adapted to exchange data with a processing device at lower-level for the uplink over a data link via an interface of the uplink interface board.

When the uplink interface board receives data transmitted from the processing device at lower-level for the uplink over the data link via the interface of the uplink interface board, the physical layer processing unit recovers a clock signal from the data link and transmits the recovered clock signal to the MAC layer processing unit for reception of the data and to a clock processing unit in the master control board for processing.

When the uplink interface board transmits data to the processing device at lower-level for the uplink over the data link, the physical layer processing unit firstly receives data transmitted from the MAC layer processing unit, then mixes the signals of the received data with a line clock signal transmitted from the processing device at upper-level for the uplink, and transmits the mixed data signals to the processing device at lower-level for the uplink over the data link.

The clock processing unit is adapted to process the recovered clock signal received to obtain a reference clock signal and to transmit the reference clock to the physical layer processing unit and the MAC layer processing unit, so that the physical layer processing unit and the MAC layer processing unit may transmit periodically the reference clock as the line clock to the processing device at lower-level for the uplink.

The MAC layer processing unit is adapted to receive data transmitted from physical layer processing unit by using the recovered clock signal from the physical layer processing unit, and to transmit the data to the physical layer processing unit by using the reference clock transmitted from the clock processing unit.

As illustrated in FIG. 2, there is provided in the downlink interface board described above a downlink interface including a clock processing unit, a MAC layer processing unit, and a physical layer processing unit.

Particularly, the physical layer processing unit is adapted to receive and transmit data over a data link in a way that the physical layer processing unit may transmit data by using a clock signal recovered from an upper-level line transmitted from the master control board, and receive data by using a local clock signal from a local interface or a clock signal from the upper-level line, and to transmit the clock signal from the upper-level line to the MAC layer processing unit. The physical layer processing unit is adapted to mix in a code mode the data signals with the clock signal recovered from the upper-level line transmitted from the master control board and transmit the mixed data signals to a processing device at lower-level for the downlink.

The clock processing unit is adapted to process the clock signals to obtain a reference clock signal and to transmit the reference clock signal to the physical layer processing unit and the MAC layer processing unit, and the physical layer processing unit and the MAC layer processing unit in the downlink interface may transmit periodically the reference clock as the line clock signal to the processing device at lower-level for the downlink.

The MAC layer processing unit is adapted to receive the data transmitted from the physical layer processing unit by using the reference clock of the clock processing unit or the line recovered clock and to transmit the data to the physical layer processing unit by using the reference clock transmitted from the clock processing unit.

The uplink interface and the downlink interface described above may be Ethernet interfaces or other IP packet network interfaces.

The uplink interface board receives the data transmitted from the processing device at lower-level for the uplink via an uplink interface such as an Ethernet interface or other interface, recovers the clock signal from the data link, and transmits the recovered clock signal to the master control board via the switching backplane. The recovered clock signal is locked by a phase locked loop circuit provided on the master control board, and the locked clock signal is driven into multiple clock signals by the signal drive circuit, and then the multiple clock signals are transmitted to a plurality of downlink interface boards via the switching backplane. The downlink interface boards each lock the clock signal output from the switching backplane, and mix the data signal with the clock signal locked by the downlink interface boards, and output the mixed signals via a downlink interface such as an Ethernet interface or other interfaces.

Descriptions will be presented below of an operational procedure for synchronization throughout the network when two different devices are interfaced via an Ethernet interface according to embodiments of the present invention, as illustrated in FIG. 3.

Clock synchronization information is required to be conveyed between Ethernet interfaces when two different devices are interfaced via the Ethernet interface. The Ethernet interface typically includes a MAC layer processing unit and a PHY layer processing unit. For clear descriptions of technical solutions of the present invention, interfacing interfaces are respectively regarded as an upper-level master device interface and a lower-level salve device interface. Particularly, the upper-level master device interface synchronizes an upper-level line clock, which is then processed by the clock processing unit to provide the MAC layer processing unit and the PHY layer processing unit respectively with a reference clock. The PHY layer processing unit mixes data with the clock information in a code mode and transmits the mixed data with clock information to the MAC layer processing unit. The MAC layer processing unit receives the data by using a clock signal recovered from the line by the PHY layer processing unit or a line clock signal transmitted from an upper-level master device.

The PHY layer processing unit of the lower-level slave device interface receives the data from a reception line, and recovers and transmits the clock signal to the MAC layer processing unit. The MAC layer processing unit receives the data by using the recovered clock signal. The recovered clock signal may be provided for the MAC layer processing unit to transmit the data. And the recovered clock signal from the reception line is transmitted to an interface device lower than the lower-level slave device interface in level after being processed by the clock processing unit in the master control board.

The Ethernet interface above mainly refers to 100BASE-X/1000BASE-X.

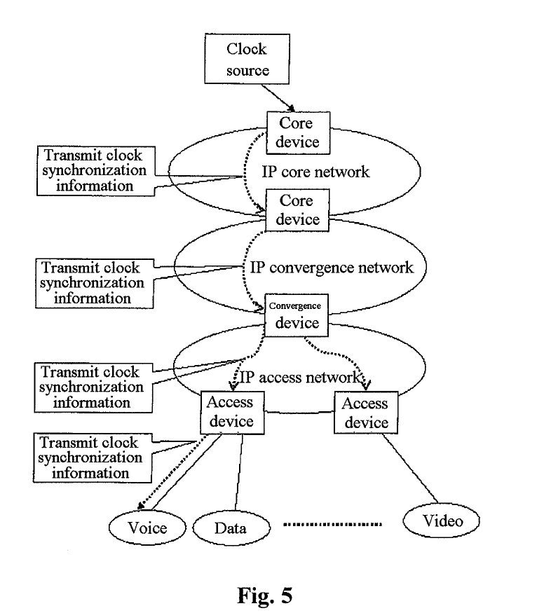

A method according to a second embodiment of the present invention is illustrated in FIG. 4.

Block 101: In a processing device, Data transmitted from a processing device at upper-level in a packet network is received over a data link and a clock signal is recovered from the data link.

Block 102: In the processing device, the recovered clock signal and the data signals are mixed and then the mixed signals are transmitted to a processing device at lower-level.

Block 103: The lower-level processing device recovers the clock signal from the data link.

Block 104: The clock signal is adaptable to be provided for a clock signal for the processing device at lower-level system itself. The processing device at lower-level mixes the clock signal and the data signals and transmits the mixed signals over a data link to a processing device at further lower-level.

The processing device at further lower-level proceeds with the block 103.

An implementation procedure according to the second embodiment of the present invention will be described in details below in connection with a schematic diagram illustrating the network architecture of an IP synchronization network illustrated in FIG. 5.

In the IP packet network, clock synchronization information is provided and conveyed via an existing data channel. A core network device is synchronized with a high-precision clock source of which the clock information is provided for use in the core network device; the core network device transmits the clock information via an in-band data channel to an IP device at a convergence layer. The IP device at the convergence layer recovers a clock from a data link and provides the recovered clock for use in the IP device at the convergence layer, and transmits the clock information of the recovered clock via an in-band data channel to an access device. In a same way of processing as the convergence device, the access device recovers the clock for use in the access device, in addition, the access device may transmit synchronization information via an data channel to a user terminal device if necessary. For example, if a PBX voice switch of a user requires synchronization with a remote synchronization network, the access device further transmits necessarily the synchronization information of the network. At this time, the PBX voice switch recovers the clock information from the data channel while receiving data from an access line and provides the recovered clock information for use by the PBX system. In this way, the clock information is conveyed level by level and locked level by level by lower-level devices to guarantee strict synchronization throughout the network, so that circuit services can be borne over the IP packet network.

As can be seen from the technical solutions above according to embodiments of the present invention, timing information for synchronization throughout the IP packet network may be provided over the network so as to implement properly uniform timing throughout the network, the IP packet network without timing is rebuilt into a synchronized network similar to a circuit network, and the advantage of a high bandwidth of the IP packet network remains. Thus, both service of circuit simulation and multi-service of high-bandwidth may be provided. Also the implementation according to embodiments of the present invention has a relatively low cost compared with rebuilding of a clock synchronization network.

In the embodiments above, descriptions have been made taking the interface board as an example. Meanwhile, the transmission module and reception module according to embodiments of the present invention may be provided not only in the interface board but also in a single board such as a service board, a network synchronization implementation of which is substantially the same as described above and descriptions thereof will not be repeated here.

The foregoing descriptions are merely illustrative of the preferred embodiments of the present invention, and the scope of the present invention shall not be limited to those embodiments. An y variations or alternatives which can readily occur to those skilled in the art in light of the technical discourse of the present invention shall fall within the scope of the claims appended to the present invention. Accordingly, the scope of the present invention shall be defined as the claims.

What is claimed is:

1. A packet communication system, comprising a plurality of processing devices, wherein at least one processing device of the plurality of processing devices is adapted to receive data signals mixed with a clock signal over a data link via an interface interfaced with a first processing device of the plurality of processing devices and recover the clock signal from the data link, and to transmit periodically the clock signal from the data link interfaced with the first processing device to a second processing of the plurality of processing devices and/or to mix data signals with the clock signal recovered from the data link interfaced with the first processing device and transmit the mixed data signals to the second processing device.

2. The system according to claim 1, wherein the plurality of processing devices are interfaced via Ethernet interfaces or other IP packet network interfaces.

3. The system according to claim 1, wherein the clock signal recovered is employed for system clock signal of the processing device itself.

4. The system according to claim 1, wherein the processing device is further adapted to mix data signals with a reference clock signal obtained by processing the recovered clock signal and to transmit the mixed data signals with the reference clock signal to the first processing device.

5. The system according to claim 1, wherein the processing device is interfaced with the first processing device via an uplink interface; and interfaced with the second processing device via a downlink interface.

6. A network device in a packet communication system, the network device comprising a plurality of interfaces, wherein:
a first interface of the plurality of interfaces interfaced with a first network device in the packet communication system, is adapted to receive data signals mixed with a clock signal over a data link via the first interface and to recover the clock signal from the data link; and
a second interface of the plurality of interfaces interfaced with a second network device in the packet communication system, is adapted to receive the clock signal recovered by the first interface and to transmit periodically the clock signal recovered by the first interface to the second network device and/or to mix data signals with the clock signal recovered by the first interface and transmit the mixed data signals to the second network device.

7. The network device according to claim 6, wherein the plurality of interfaces are provided in interface boards or service boards.

8. The network device according to claim 6, wherein the first interface is a uplink interface, and the second interface is a downlink interface.

9. The network device according to claim 6, wherein the plurality of interfaces are Ethernet interfaces or other IP packet network interfaces.

10. The network device according to claim 6, the first interface is further adapted to transmit the clock signal recovered by the first interface to the second interface via a phase locked loop circuit and a signal drive circuit; wherein: the phase locked loop circuit is adapted to lock the clock signal from the first interface, and the signal drive circuit is adapted to drive the clock signal locked by the phase locked loop circuit into multiple signals and to transmit the multiple signals to the corresponding second interface.

11. The network device according to claim 6, wherein the second interface transmits data to the second network device by using the recovered by the first interface or a reference clock signal processed by the second interface.

12. The network device according to claim 6, wherein the first interface further processes the clock signal recovered by the first interface to obtain a reference clock signal for reception of data via the first interface, or
the second interface further processes the clock signal recovered by the second interface to obtain a reference clock signal for reception of data via the second interface.

13. A method for network synchronization in a packet communication system, the method comprising:
receiving data signals mixed a clock signal over a data link via a first interface interfaced with a processing device in the packet communication system
recovering the clock signal from the data link;
mixing data signals with the clock signal recovered from the data link via the first interface in a code mode; and
transmitting via a second interface interfaced with a second processing device in the packet communication system the mixed data signals with the clock signal recovered from the data link via the second interface.

14. The method according to claim 1, before mixing data signals with the clock signal recovered from the data link via the first interface, the method further comprising:
locking the clock signal from the data link via the first interface; and
driving the locked signal into multiple signals provided for the corresponding second interface.
